(19) United States
(12) Patent Application Publication
(10) Pub. No.: US 2007/0037060 A1
(43) Pub. Date: Feb. 15, 2007

(54) All-solid-state primary film battery and method of manufacturing the same

(76) Inventors: Young Gi Lee, Daejeon-city (KR); Kwang Man Kim, Daejeon-city (KR); Kwang Sun Ryu, Daejeon-city (KR); Soon Ho Chang, Daejeon-city (KR)

Correspondence Address: LADAS & PARRY LLP, 224 SOUTH MICHIGAN AVENUE, SUITE 1600, CHICAGO, IL, 60604, US

(21) Appl. No.: 11/509,195

(22) Filed: Aug. 23, 2006

(30) Foreign Application Priority Data
Aug. 12, 2005 (KR) 10-2005-0120032
Aug. 3, 2006 (KR) 10-2006-0021873

(51) Int. Cl. H01M 10/40; H01M 4/66; H01M 4/62; H01M 10/04

(52) U.S. Cl. 429/306; 429/245; 429/232; 429/317; 429/314; 429/316; 29/623.5

(57) ABSTRACT

Provided are an all-solid state primary film battery, and a method of manufacturing the same. The all-solid state primary film battery includes: a first polymer current collector film including a first polymer film and a first conductive layer; a first electrode layer formed on the first conductive layer; a second polymer current collector film that includes a second polymer film and a second conductive layer; a second electrode layer formed on the second conductive layer; and a polymer electrolyte layer including aqua-based electrolytic solution, and is formed between the first electrode layer and the second electrode layer.

### CROSS-REFERENCE TO RELATED PATENT APPLICATION

This application claims the benefit of Korean Patent Application Nos. 10-2005-0120032, filed on Dec. 8, 2005 and 10-2006-0021873, filed on Mar. 8, 2006 in the Korean Intellectual Property Office, the disclosures of which are incorporated herein in their entirety by reference.

### BACKGROUND OF THE INVENTION

1. Field of the Invention

The present invention relates to a primary battery and a method of manufacturing the same, and more particularly, to an all-solid-state primary film battery and a method of manufacturing the same.

2. Description of the Related Art

Active type Radio Frequency Identification (RFID) and a sensor node, on which active research has been conducted recently, have far-reaching implications for digital televisions, home networks, artificial robots, etc., thus active type RFID and the sensor node are expected to be more widely used than the Code Division Multiple Access (CDMA) technique and become a core industry. That is, active type RFID and the sensor node are expected to deviate from a passive function of reading information included in a tag through a reader, and innovatively increase the recognition distance of tags. In addition, by sensing information about an object located around a tag and environmental information, active type RFID and the sensor node are expected to enlarge a scope of information flow which includes communication between people and objects and communication between objects by means of networks. Therefore, in order to drive RFID and a sensor node, it is important that a power source, which is micromini and lightweight so as to be suitable for tags or nodes and has good durability, be used, and that a power source completely independent from the reader be secured.

To date, lithium secondary batteries, which are typical power sources, have been partly applied to RFID and a sensor node, and, the possibility of using lithium secondary batteries is acknowledged. Lithium secondary batteries include an anode and a cathode formed using a method that material, in which intercalation and deintercalation of lithium ions can be realized, is used as active material. An organic electrolyte or polymer electrolyte, in which lithium ions can move, is inserted between the anode and the cathode. Here, the anode has a structure in which active material is coated on an aluminium current collector having a thickness of about 20 mm, and the cathode has a structure in which active material is coated on a copper current collector. Lithium secondary batteries are applied to some sensor nodes. However, the cost of lithium secondary batteries is high and the performance thereof is poor, and thus lithium secondary batteries are not suitable for tags. It is not easy to recharge discharged tags because of the nature of their use. Also, a metal current collector in a lithium secondary battery causes interference with electromagnetic waves of an antenna in a tag. Thus, it is difficult to practically apply lithium secondary batteries to active type tags.

### SUMMARY OF THE INVENTION

The present invention provides a primary film battery, which is lighter and thinner than a conventional battery. According to the present invention, the flexibility of the primary film battery can be enhanced. The primary film battery has a high energy density, and the primary film battery has a characteristic suitable for applying to a tag in order to solve the above-described problems of the conventional art.

The present invention also provides a simple and easy method of manufacturing the primary film battery, in which relatively less strict process conditions may be applied. Thus, according to the present invention, a perfect continuous, cheap manufacturing process and mass production can be realized.

According to an aspect of the present invention, there is provided an all-solid state primary film battery including: a first polymer current collector film including a first polymer film and a first conductive layer; a first electrode layer formed on the first conductive layer; a second polymer current collector film including a second polymer film and a second conductive layer; a second electrode layer formed on the second conductive layer; and a polymer electrolyte layer including aqua-based electrolytic solution, and being formed between the first electrode layer and the second electrode layer.

According to another aspect of the present invention, there is provided the all-solid state primary battery, wherein the first polymer film and the second polymer film each include a polyester-based polymer, a polyolefine-based polymer, or a combination thereof.

According to another aspect of the present invention, there is provided the all-solid state primary battery, wherein the first polymer film and the second polymer film each have a single-layer or multi-layer structure that is formed of a single kind of polymer, or a multi-layer structure that is formed of at least two different kinds of polymers.

According to another aspect of the present invention, there is provided the all-solid state primary battery, wherein the first conductive layer and the second conductive layer each include a conductive carbon paste coating layer, a nano metal particle paste coating layer, a conductive polymer coating layer, an indium tin oxide (ITO) paste coating layer, or a conductive carbon tape.

According to another aspect of the present invention, there is provided the all-solid state primary battery, wherein the first electrode layer includes a mixture of a first conductor, a first polymer binder and anode active material, and the second electrode layer includes a mixture of a second conductor, a second polymer binder and cathode active material.

According to another aspect of the present invention, there is provided the all-solid state primary batter, wherein the first conductor and the second conductor each include one conductive carbon selected from the group consisting of graphite, carbonblack, denkablack, ronza carbon, super-P, and active carbon MSC30.

According to another aspect of the present invention, there is provided the all-solid state primary battery, wherein the first polymer binder and the second polymer binder each include any one polymer selected from the group consisting of polytetrafluoroethylene, polyvinylidenefluoride, a copolymer of vinylidenefluoride and hexafluoropropylene, a copolymer of vinylidenefluoride and trifluoroethylene, a copolymer of vinylidenefluoride and tetrafluoroethylene, polyethyleneoxide, polypropyleneoxide, polyvinylchloride, polybutadiene, polystyrene, polyethylene, polypropylene, polymethylacrylate, polyethylacrylate, polymethylmethacrylate, polyethylmethacrylate, polybutylacrylate, polybutylmethacrylate, polyacrylonitrile, cellulose, carboxymethylcellulose, starch, polyacrylic acid, polyvinyl alcohol, polyvinyl acetate, nylon and nafion, a copolymer thereof and a mixture thereof.

According to another aspect of the present invention, there is provided the all-solid state primary battery, wherein the anode active material includes manganeseoxide electrolytic manganese dioxide (EMD), nickeloxide, lead oxide, lead dioxide, silver oxide, iron sulfide, or conductive polymer, and has a particle diameter of 10 nm-50 μm.

According to another aspect of the present invention, there is provided the all-solid state primary battery, wherein the polymer electrolyte layer includes polymer matrix, inorganic additive, and aqua-based electrolytic solution having salt.

According to another aspect of the present invention, there is provided the all-solid state primary battery, wherein the polymer matrix includes any one selected from the group consisting of polyethylene, polypropylene, polyimide, polysulfone, polyurethane, polyvinylchloride, polystyrene, polyethyleneoxide, polypropyleneoxide, polybutadiene, cellulose, carboxymethylcellulose, nylon, polyacrylonitrile, polyvinylidenefluoride, polytetrafluoroethylene, a copolymer of vinylidenefluoride and hexafluoropropylene, a copolymer of vinylidenefluoride and trifluoroethylene, copolymer of vinylidenefluoride and tetrafluoroethylene, polymethylacrylate, polyethylacrylate, polymethylmethacrylate, polyethylmethacrylate, polybutylacrylate, polybutylmethacrylate, polyvinyl acetate, polyvinyl alcohol, starch, agar and nafion, a copolymer thereof or a mixture thereof.

According to another aspect of the present invention, there is provided the all-solid state primary battery, wherein the inorganic additive includes at least one selected from the group consisting of silica, talc, aluminum oxide (Al₂O₃), TiO₂, clay and zeolite.

According to another aspect of the present invention, there is provided the all-solid state primary battery, wherein the aqua-based electrolytic solution includes distilled water.

According to another aspect of the present invention, there is provided the all-solid state primary battery, wherein a salt in the aqua-based electrolytic solution includes at least one selected from the group consisting of potassium hydroxide (KOH), potassium bromide (KBr), potassium chloride (KCl), zinc chloride (ZnCl₂), ammonium chloride (NH₄Cl), and sulfuric acid (H₂SO₄).

According to another aspect of the present invention, there is provided a method of manufacturing an all-solid state primary film battery including: preparing a first polymer film and a second polymer film; forming a first conductive layer on the first polymer film to form a first polymer current collector film; forming a second conductive layer on the second polymer film to form a second polymer current collector film; forming a first electrode layer on the first polymer current collector film; forming a second electrode layer on the second polymer current collector film; forming a polymer electrolyte layer including aqua-based electrolytic solution between the first electrode layer and the second electrode layer.

According to another aspect of the present invention, there is provided the method, wherein the forming the first conductive layer includes coating a conductive carbon paste, a nano metal particle paste, a conductive polymer or an ITO paste on the first polymer film, or attaching a conductive carbon tape to the first polymer film.

According to another aspect of the present invention, there is provided the method, wherein the forming the second conductive layer includes coating a conductive carbon paste, a nano metal particle paste, a conductive polymer, or an ITO paste on the second polymer film, or attaching a conductive carbon tape to the second polymer film.

The all-solid-state primary film battery according to the present invention minimizes metal usage and can drastically lighten the weight of the all-solid-state primary film battery compared with a conventional current collector. The flexibility of the all-solid-state primary film battery is excellent because of the nature of a polymer film, and thus an electrode layer can be prevented from being exfoliated and damaged when the film is folded. The all-solid-state primary film battery according to the present invention can be easily applied to a wearable personal computer and the like because it can be rolled and bent such as a roller. According to the method of manufacturing the all-solid-state primary film battery according to the present invention, because manufacturing conditions such as tension and the like in continuous manufacturing process are very easier compared with conventional methods using a metal current collector, the mass-production of cells can be facilitated.

### BRIEF DESCRIPTION OF THE DRAWINGS

The above and other features and advantages of the present invention will become more apparent by describing in detail exemplary embodiments thereof with reference to the attached drawings in which:

FIG. 1 is a sectional view illustrating a structure of an all-solid-state primary film battery according to an embodiment of the present invention;

FIG. 2 is a flowchart illustrating a method of manufacturing an all-solid-state primary film battery according to an embodiment of the present invention;

FIG. 3 is a graph illustrating a discharge characteristic of a single cell of a primary film battery according to an embodiment of the present invention;

FIG. 4 is a graph illustrating discharge capacities of embodiments of the present invention together with a comparative example;

FIG. 5 is a graph illustrating variation of an open circuit voltage (OCV) of primary film batteries according to embodiments of the present invention according to time at a normal temperature together with the comparative example; and

FIG. 6 is a graph illustrating variation of internal resistance of primary film batteries according to embodiments of the present invention according to time at a normal temperature a together with the comparative example.

### DETAILED DESCRIPTION OF THE INVENTION

Hereinafter, the present embodiments will be described in detail with reference to the attached drawings.

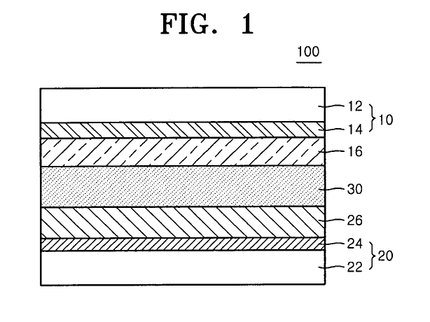

FIG. 1 is a sectional view illustrating a structure of an all-solid-state primary film battery 100 according to an embodiment of the present invention.

Referring to FIG. 1, the all-solid-state primary film battery 100 includes a first polymer current collector film 10 and a second polymer current collector film 20.

The first polymer current collector film 10 includes a first polymer film 12 and a first conductive layer 14. The second polymer current collector film 20 includes a second polymer film 22 and a second conductive layer 24.

The first polymer film 12 and the second polymer film 22 each inhibit transmission of water and oxygen into an internal part of the all-solid-state primary film battery 100. The first polymer film 12 and the second polymer film 22 may have a single-layer or multi-layer structure formed of specific polymer material which may be selected according to characteristics such as mechanical strength, transmission of water and oxygen, and etc. For example, each of the first polymer film 12 and the second polymer film 22 may be a laminated polymer film including a polyester-based polymer such as polyethyleneterephthalate, polybutyleneterephthalate, etc.; a polyolefine-based polymer such as polyethylene, polypropylene, etc; or combinations thereof, thus each of the first polymer film 12 and the second polymer film 22 may have a single-layer or multi-layer structure. Alternatively, the first polymer film 12 and the second polymer film 22 may be laminated and may have a multi-layer structure including combinations of polyester-based polymer film and polyolefine-based polymer. Each of the first polymer film 12 and the second polymer film 22 may be formed to have a thickness of about 5-100 μm.

The first conductive layer 14 and the second conductive layer 24 are thin films formed using a method in which conductive materials are coated on one side of the first polymer film 12 and the second polymer film 22, respectively. The first conductive layer 14 and the second conductive layer 24 may be formed by coating each of a conductive carbon paste, a nano metal particle (metal particle having particle diameter of several or several tens of nanometer) paste, a conductive polymer, or an indium tin oxide (ITO) paste on one side of the first polymer film 12 and the second polymer film 22, or alternatively, by attaching conductive carbon tapes on one side of the first polymer film 12 and the second polymer film 22. Each of the first conductive layer 14 and the second conductive layer 24 may be formed to have a thickness of about 10 Å-50 μm, preferably about 5-150 μm.

The first conductive layer 14 and the second conductive layer 24 of the first polymer current collector film 10 and the second polymer current collector film 20, respectively, play roles as current collectors. The first polymer film 12 and the second polymer film 22 perform functions as packing material.

The first polymer current collector film 10 and the second polymer current collector film 20 may be formed such that usage of metal is minimized. Thus, comparing the first polymer current collector film 10 and the second polymer current collector film 20 with a conventional metal current collector, the manufacturing processes are almost the same, but the first polymer current collector film 10 and the second polymer current collector film 20 can be significantly thinner, and the first polymer current collector film 10 and the second polymer current collector film 20 can be significantly lighter.

In addition, owing to the first polymer film 12 and the second polymer film 22, flexibility is very excellent, and a lapping phenomenon does not occur. The first polymer film 12 and the second polymer film 22 can play roles additionally as packing material which prevents external water or oxygen from entering the all-solid-state primary film battery 100. Thus, it is easy to manufacture encapsulated type batteries.

An anode layer 16 is coated on the first polymer current collector film 10, and a cathode layer 26 is coated on the second polymer current collector film 20.

The anode layer 16 may be formed by coating slurry including a mixture including a conductor, a polymer binder and anode active material on the first conductive layer 14 of the first polymer current collector film 10.

The anode layer 16 may be formed to have a thickness of about 5-200 μm. The total thickness of the first polymer current collector film 10 and the anode layer 16 may be about 10-350 μm.

The anode layer 16 may be formed of conductive carbon such as graphite, carbon black, dencablack, ronza carbon, super-P, MSC30, etc. which are conductors suitable for forming the anode layer 16.

The anode layer 16 may formed of a polymer binder suitable for forming the anode layer 16. Examples of the polymer binder suitable for forming the anode layer 16 may include polytetrafluoroethylene, polyvinylidenefluoride, a copolymer of vinylidenefluoride and hexafluoropropylene, a copolymer of vinylidenefluoride and trifluoroethylene, a copolymer of vinylidenefluoride and tetrafluoroethylene, a polymer such as polyethyleneoxide, polypropyleneoxide, polyvinylchloride, polybutadiene, polystyrene, polyethylene, polypropylene, polymethylacrylate, polyethylacrylate, polymethylmethacrylate, polyethylmethacrylate, polybutylacrylate, polybutylmethacrylate, polyacrylonitrile, cellulose, carboxymethylcellulose, starch, polyacrylic acid, polyvinyl alcohol, polyvinyl acetate, nylon, nafion, etc., a copolymer thereof, and a mixture of the above materials.

The anode layer 16 may be formed of an anode active material suitable for forming the anode layer 16. Examples of the anode active material suitable for forming the anode layer 16 may include manganeseoxide, electrolytic manganese dioxide (EMD), nickeloxide, lead oxide, lead dioxide, silveroxide, iron sulfide, conductive polymer particles, etc. A particle size of the anode active material may be about 10 nm-50 μm.

The cathode layer 26 may be formed by coating slurry including a mixture including a conductor, a polymer binder and cathode active material on the second conductive layer 24 of the second polymer current collector film 20.

The cathode layer 26 may be formed to have a thickness of about 5-200 μm. The total thickness of the second polymer current collector film 20 and the cathode layer 26 may be about 10-350 μm.

The cathode layer 26 may be formed of conductive carbon such as graphite, carbonblack, denkablack, ronza carbon, super-P, active carbon MSC30, etc. which are conductors suitable for forming the cathode layer 26.

The cathode layer 26 may be formed of a polymer binder suitable for forming the cathode layer 26. Examples of the polymer binder suitable for forming the cathode layer 26 may include polytetrafluoroethylene, polyvinylidenefluoride, a copolymer of vinylidenefluoride and hexafluoropropylene, a copolymer of vinylidenefluoride and trifluoroethylene, a copolymer of vinylidenefluoride and tetrafluoroethylene, a polymer such as polyethyleneoxide, polypropyleneoxide, polyvinylchloride, polybutadiene, polystyrene, polyethylene, polypropylene, polymethylacrylate, polyethylacrylate, polymethylmethacrylate, polyethylmethacrylate, polybutylacrylate, polybutylmethacrylate, polyacrylonitrile, cellulose, carboxymethylcellulose, starch, polyacrylic acid, polyvinyl alcohol, polyvinyl acetate, nylon, nafion, etc., a copolymer thereof, and a mixture of the above materials.

The cathode layer 26 may be formed of a cathode active material suitable for forming the cathode layer 26. The cathode active material may include zinc, aluminum, iron, lead, magnesium particles, and the like. A particle size of the cathode active material may be about 10 nm through 50 μm.

A polymer electrolyte layer 30, which adheres the anode layer 16 and the cathode layer 26 and provides a moving path of ions between the anode layer 16 and the cathode layer 26, is formed between the anode layer 16 and the cathode layer 26.

The polymer electrolyte layer 30 is formed of a polymer film including aqua-based electrolytic solution. By locating the polymer electrolyte layer 30 between the anode layer 16 and the cathode layer 26, an adhesion between the anode layer 16 and the cathode layer 26 is strengthened and these provides an integration of film battery. Also, the polymer electrolyte layer 30, which is a thin film, plays roles as both electrolyte and membrane, and thus a thickness of the all-solid-state primary film battery 100 is drastically reduced. With respect to the all-solid-state primary film battery 100, flexibility is excellent, conditions of processes such as winding or stacking can be easier, price competitiveness can be better, and energy density per weight can be increased.

The polymer electrolyte layer 30 may be formed to have a thickness of about 5-200 μm.

The polymer electrolyte layer 30 includes polymer matrix, inorganic additive, and aqua-based electrolytic solution.

The polymer electrolyte layer 30 may be formed of a polymer matrix suitable for forming the polymer electrolyte layer 30. Here, examples of the polymer matrix suitable for forming the polymer electrolyte layer 30 may include polyethylene, polypropylene, polyimide, polysulfone, polyurethane, polyvinylchloride, polystyrene, polyethyleneoxide, polypropyleneoxide, polybutadiene, cellulose, carboxymethylcellulose, nylon, polyacrylonitrile, polyvinylidenefluoride, polytetrafluoroethylene, copolymer of vinylidenefluoride and hexafluoropropylene, copolymer of vinylidenefluoride and trifluoroethylene, copolymer of vinylidenefluoride and tetrafluoroethylene, polymethylacrylate, polyethylacrylate, polymethylmethacrylate, polyethylmethacrylate, polybutylacrylate, polybutylmethacrylate, polyvinyl acetate, polyvinyl alcohol, starch, agar, nafion, etc., a copolymer thereof, and a mixture of the above materials.

The polymer electrolyte layer 30 may formed of an inorganic additive suitable for forming the polymer electrolyte 30. The inorganic additive suitable for forming the polymer electrolyte 30 may be selected from the group consisting of silica, talc, aluminum oxide (Al₂O₃), TiO₂, clay, zeolite, and a mixture thereof. About 1 through 100 weight % of the inorganic additive may be included in the polymer electrolyte layer 30 based on the total weight of polymer included in the polymer matrix.

The polymer electrolyte layer 30 may be formed of an aqua-based electrolytic solution suitable for forming the polymer electrolyte layer 30. The aqua-based electrolytic solution suitable for forming the polymer electrolyte layer 30 may include distilled water. About 1-500 weight % of the aqua-based electrolytic solution may be included in the polymer electrolyte layer 30 based on the total weight of polymer included in the polymer matrix.

Salt in the aqua-based electrolytic solution may be at least one selected from the group consisting of potassium hydroxide (KOH), potassium bromide (KBr), potassium chloride (KCl), zinc chloride (ZnCl₂), ammonium chloride (NH₄Cl), and sulfuric acid (H₂SO₄). An aqueous solution, in which about 0.1-10 M of the above salt is dissolved, may be used as the aqua-based electrolytic solution.

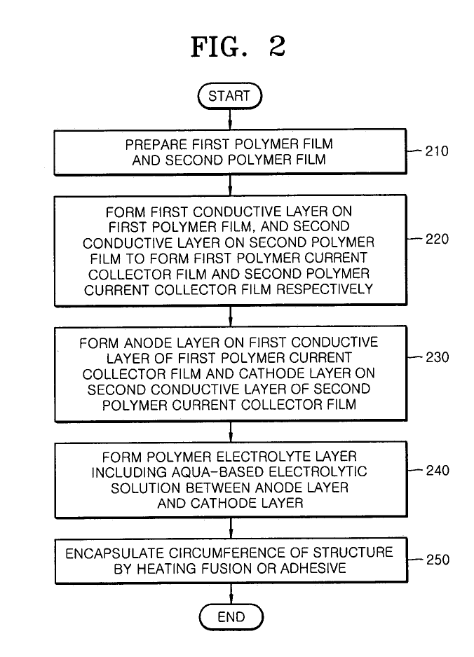

FIG. 2 is a flowchart illustrating a method of manufacturing the all-solid-state primary film battery 100 according to an embodiment of the present invention. The method of manufacturing the all-solid-state primary film battery 100 according to the exemplary embodiment of the present invention will be described with reference to FIGS. 1 and 2.

First, in operation 210, the first polymer film 12 and the second polymer film 22 are prepared.

In operation 220, the first conductive layer 14 is formed on the first polymer film 12, and the second conductive layer 24 is formed on the second polymer film 22. Thus the first polymer current collector film 10 and the second polymer current collector film 20 are formed.

In operation 230, the anode active material slurry is coated on the first conductive layer 14 of the first polymer current collector film 10 to form the anode layer 16. Also, the cathode active material slurry is coated on the conductive layer 24 of the second polymer current collector film 20 to form the cathode layer 26.

The anode active material slurry for forming the anode layer 16 may include a mixture of the conductor, polymer binder and anode active material. The cathode active material slurry for forming the cathode layer 26 may include a mixture of the conductor, polymer binder and cathode active material. Detailed descriptions of the anode active material slurry and the cathode active material slurry have been provided previously.

In operation 240, the polymer electrolyte layer 30 including the aqua-based electrolytic solution between the anode layer 16 and the cathode layer 26 is formed, and thus a structure as illustrated in FIG. 1 is completed. In order to form the above structure, the polymer film including the organic electrolyte may be coated or laminated on each of the anode layer 16 and the cathode layer 26.

In operation 250, a circumference of the structure as illustrated in FIG. 1 obtained by operations 210 through 240 is encapsulated by heating fusion or adhesive, and thus the all-solid-state primary film battery 100 is formed.

With respect to the all-solid-state primary film battery 100 according to the current embodiment of the present invention as described with reference to FIGS. 1 and 2, the interface adhesion between an electrode and electrolyte can increase, and the longevity and durability can be extended. Micromini and encapsulated type single cells can be implemented by the all-solid-state primary film battery 100 according to the current embodiment of the present invention. Also, winding and stacking processes performed by the all-solid-state primary film battery 100 according to the current embodiment of the present invention can be simplified.

A manufacturing method of the all-solid-state primary film battery 100 according to the current embodiment of the present invention will be described in further detail with reference to the following examples. These examples are for illustrative purposes only and are not intended to limit the scope of the present invention.

### EXAMPLE 1

A polyester-based film having a two-layer structure was formed by laminating a transparent polyethyleneterephthalate film having a thickness of 15 μm and an opaque polyethyleneterephthalate film having a thickness of 35 μm. Here, both sides of the transparent polyethyleneterephthalate film and the opaque polyethyleneterephthalate film had been each surface-treated by corona discharge before the lamination was performed. A conductive carbon paste having a thickness of 10 μm was coated on one side of the polyester-based film, and thus a polymer current collector film for an anode was formed.

### EXAMPLE 2

A polymer current collector film for an anode was formed using the same method as in Example 1 except that a transparent polyethyleneterephthalate film having a thickness of 5 μm and an opaque polyethyleneterephthalate film having a thickness of 10 μm were used.

### EXAMPLE 3

A polyester-based film having a two-layer structure was formed by laminating a transparent polyethyleneterephthalate film having a thickness of 15 μm and an opaque polyethyleneterephthalate film having a thickness of 35 μm. Here, both sides of the transparent polyethyleneterephthalate film and the opaque polyethyleneterephthalate film had been surface-treated by corona discharge before the lamination was performed. A conductive carbon paste having a thickness of 10 μm was coated on one side of the manufactured polyester-based film, and thus a polymer current collector film for a cathode was formed.

### EXAMPLE 4

A polymer current collector film for a cathode was formed using the same method as in Example 3 except that a transparent polyethyleneterephthalate film having a thickness of 5 μm and an opaque polyethyleneterephthalate film having a thickness of 10 μm were used,.

### EXAMPLE 5

Slurry of EMD anode active material whose mean particle diameter was about 2 μm was coated with a thickness of 60 μm on the conductive layer of the polymer current collector film for the anode having a thickness of 60 μm manufactured in Example 1, and slurry of zinc cathode active material whose mean particle diameter was about 300 nm was coated with a thickness of 60 μm on the conductive layer of the polymer current collector for the cathode having a thickness of 60 μm manufactured in Example 4, and thus electrode films were formed. Here, as the slurry of the anode active material, a mixture of EMD oxide compound powder (90 weight % EMD oxide+5 weight % 6M calcium hydroxide electrolyte+5 weight % carboxymethylcellulous) 80 weight %, graphite 12 weight %, and polyvinylchloride 8 weight % were used. As the slurry of the cathode active material slurry, a mixture of zinc compound powder (90 weight % zinc+5 weight % 6M calcium hydroxide electrolyte+5 weight % carboxymethylcellulous) 80 weight %, graphite 12 weight %, and polysodiumvinyl 8 weight % were used. A film having a thickness of 25 μm formed of a blend of 60 weight % of copolymer of vinylidenefluoride and hexafluoropropylene, and 40 weight % polyethyleneoxide polymer was inserted and laminated between two manufactured electrode films. Sequentially, 6M potassium hydroxide solution was impregnated and a 1.5 V single cell of a primary film battery having a 2 cm×2 cm electrode size was formed.

### EXAMPLE 6

A single cell of a primary film battery was formed using the same method as in Example 5 except that slurry of EMD anode active material whose mean particle diameter was about 0.5 μm and slurry of zinc cathode active material whose mean particle diameter was about 60 nm were used.

### COMPARATIVE EXAMPLE

In order to provide a comparison with properties of the primary film battery obtained in Examples 5 and 6 respectively, two SUS current collectors having 15 μm thicknesses were prepared, and slurry of EMD anode active material whose mean particle was about 20 μm and slurry of zinc cathode active material whose mean particle was about 75 μm were coated to 60 μm thicknesses on the SUS current collectors respectively. Thus anode and cathode films were formed.

Here, the anode active material slurry and the cathode active material slurry, whose materials were the same as in Examples 5 and 6, were used. A membrane for an alkali battery was inserted between the manufactured anode and cathode films. Lamination was performed so that a thickness of a polymer electrolyte layer might be regulated to be the same as in Example 5. Sequentially, the same electrolyte as in Example 5 was injected to form a single cell of a primary film battery.

### ESTIMATION EXAMPLE

The single cells of the primary film battery manufactured in Examples 5 and 6, and the primary battery manufactured in the Comparative Example were discharged to 1.0 V with a current density of 1 mA, respectively.

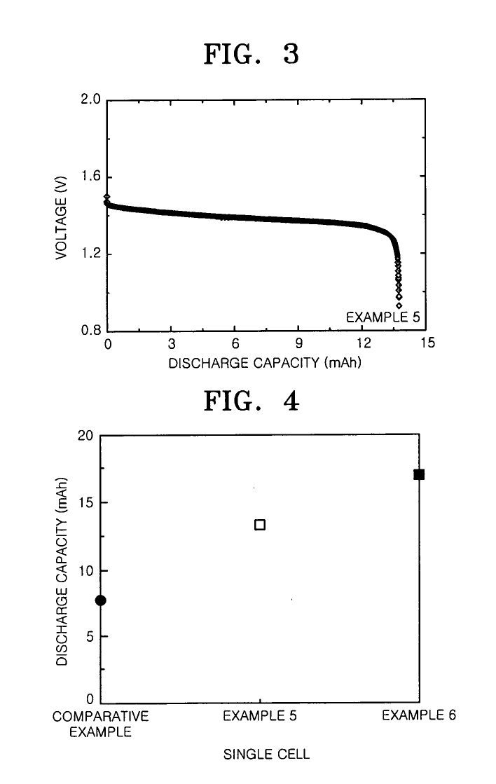

FIG. 3 is a graph illustrating discharge characteristics of the single cell of the primary film battery of Example 5 according to an embodiment of the present invention.

FIG. 4 is a graph illustrating discharge capacities of the primary film batteries of Examples 5 (□) and 6 (▪) according to the present invention and Comparative Example (●). Referring to FIG. 4, it was noted that with respect to the primary film batteries, a surface adhesion between an electrode and electrolyte was increased. Also, because the primary film batteries of Examples 5 and 6 were thin and light, excellent discharge capacity and energy density were achieved.

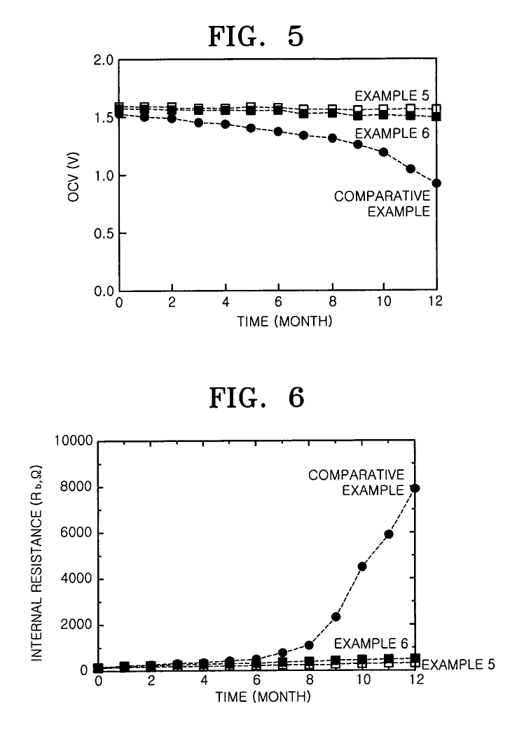

FIG. 5 is a graph illustrating variation of an open circuit voltage (OCV) of the primary film batteries of Examples 5 (□) and 6 (▪) according to time at a normal temperature together with the Comparative Example (●).

Referring to FIG. 5, it was noted that with respect to the primary film batteries of Examples 5 and 6, a voltage drop and a self discharge were inhibited compared with the Comparative Example. That was because the polymer electrolyte was introduced in aqua-based electrolytic solution in the primary film battery according to the present invention, and therefore, direct contacts between electrodes or between an electrode and an electrolyte were prevented, and a corrosion of cathode and a polarization following the corrosion were inhibited.

FIG. 6 is a graph illustrating variation of internal resistance of the primary film batteries of Examples 5 (□) and 6 (▪) according to time at a normal temperature together with the Comparative Example (●).

Referring to FIG. 6, variations of internal resistance of the primary film batteries according to Examples 5 and 6 of the present invention are small compared with the Comparative Example. From the results of FIG. 6, with regard to the primary film batteries according to the present invention, it is noted that owing to using a polymer electrolyte introduced in an aqua-based electrolytic solution, interactions between polymer matrix and water and between inorganic additives in electrolyte, and water inhibit vaporization and a water leakage for a long time. That is, stability over time of the primary film battery according to the present invention is excellent.

Polymer current collector, which is manufactured by coating a thin film of a conductive carbon paste, a nano metal particle paste, a conductive polymer or an ITO paste on a thin polymer film, or by attaching a conductive carbon adhesive tape on a thin polymer film, is used in the primary battery according to the present invention. Therefore, the primary film battery according to the present invention minimizes metal usage and can drastically lighten the weight of the primary film battery compared with a conventional current collector. Flexibility of the primary film battery is excellent because of the nature of a polymer film, and thus the electrode layer can be prevented from being exfoliated and damaged when the polymer film is folded. The primary film battery according to the present invention can be easily applied to a wearable personal computer, etc. because the primary film battery can be rolled or bent. Also, when a battery is implemented by winding and stacking, excellent packing density and enhanced energy density per weight can be achieved.

According to the method of manufacturing the primary film battery according to the present invention, because manufacturing conditions such as tension, etc. at continuous manufacturing process are much easier compared with conventional methods using a metal current collector, cells can be mass-produced. The current collector film also plays a role as packing material. Thus, the current collector film is very useful in a single cell or a tiny encapsulated type primary film battery, particularly, batteries for RFID tags or cosmetics. Leakage can be prevented compared with conventional systems using a system of liquid electrolyte/membrane by using a polymer electrolyte. Thus, the method according to the present invention has an advantage in terms of stability.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An all-solid state primary film battery comprising:
a first polymer current collector film comprising a first polymer film and
a first conductive layer;
a first electrode layer formed on the first conductive layer;
a second polymer current collector film comprising a second polymer film and a second conductive layer;
a second electrode layer formed on the second conductive layer; and
a polymer electrolyte layer comprising aqua-based electrolytic solution, and being formed between the first electrode layer and the second electrode layer.

2. The all-solid state primary battery of claim 1, wherein the first polymer film and the second polymer film each comprise a polyester-based polymer, a polyolefine-based polymer, or a combination thereof.

3. The all-solid state primary battery of claim 1, wherein the first polymer film and the second polymer film each have a single-layer or multi-layer structure that is formed of a single kind of polymer, or a multi-layer structure that is formed of at least two different kinds of polymers.

4. The all-solid state primary battery of claim 1, wherein the first conductive layer and the second conductive layer each comprise a conductive carbon paste coating layer, a nano metal particle paste coating layer, a conductive polymer coating layer, an indium tin oxide (ITO) paste coating layer, or a conductive carbon tape.

5. The all-solid state primary battery of claim 1, wherein the first electrode layer comprises a mixture of a first conductor, a first polymer binder and anode active material, and
the second electrode layer comprises a mixture of a second conductor, a second polymer binder and cathode active material.

6. The all-solid state primary battery of claim 5, wherein the first conductor and the second conductor each comprise one conductive carbon selected from the group consisting of graphite, carbonblack, denkablack, ronza carbon, super-P, and active carbon MSC30.

7. The all-solid state primary battery of claim 5, wherein the first polymer binder and the second polymer binder each comprise any one polymer selected from the group consisting of polytetrafluoroethylene, polyvinylidenefluoride, a copolymer of vinylidenefluoride and hexafluoropropylene, a copolymer of vinylidenefluoride and trifluoroethylene, a copolymer of vinylidenefluoride and tetrafluoroethylene, polyethyleneoxide, polypropyleneoxide, polyvinylchloride, polybutadiene, polystyrene, polyethylene, polypropylene, polymethylacrylate, polyethylacrylate, polymethylmethacrylate, polyethylmethacrylate, polybutylacrylate, polybutylmethacrylate, polyacrylonitrile, cellulose, carboxymethylcellulose, starch, polyacrylic acid, polyvinyl alcohol, polyvinyl acetate, nylon and nafion, a copolymer thereof and a mixture thereof.

8. The all-solid state primary battery of claim 5, wherein the anode active material comprises manganeseoxide electrolytic manganese dioxide (EMD), nickeloxide, lead oxide, lead dioxide, silver oxide, iron sulfide, or conductive polymer, and has a particle diameter of 10 nm-50 μm.

9. The all-solid state primary battery of claim 5, wherein the cathode active material comprises zinc, aluminium, iron, plumbum or magnesium, and has a particle diameter of 10 nm-50 μm.

10. The all-solid state primary battery of claim 1, wherein the polymer electrolyte layer comprises polymer matrix, inorganic additive, and aqua-based electrolytic solution having salt.

11. The all-solid state primary battery of claim 10, wherein the polymer matrix comprises any one selected from the group consisting of polyethylene, polypropylene, polyimide, polysulfone, polyurethane, polyvinylchloride, polystyrene, polyethyleneoxide, polypropyleneoxide, polybutadiene, cellulose, carboxymethylcellulose, nylon, polyacrylonitrile, polyvinylidenefluoride, polytetrafluoroethylene, a copolymer of vinylidenefluoride and hexafluoropropylene, a copolymer of vinylidenefluoride and trifluoroethylene, copolymer of vinylidenefluoride and tetrafluoroethylene, polymethylacrylate, polyethylacrylate, polymethylmethacrylate, polyethylmethacrylate, polybutylacrylate, polybutylmethacrylate, polyvinyl acetate, polyvinyl alcohol, starch, agar and nafion, a copolymer thereof or a mixture thereof.

12. The all-solid state primary battery of claim 10, wherein the inorganic additive comprises at least one selected from the group consisting of silica, talc, aluminum oxide (Al₂O₃), TiO₂, clay and zeolite.

13. The all-solid state primary battery of claim 10, wherein the aqua-based electrolytic solution comprises distilled water.

14. The all-solid state primary battery of claim 10, wherein a salt in the aqua-based electrolytic solution comprises at least one selected from the group consisting of potassium hydroxide (KOH), potassium bromide (KBr), potassium chloride (KCl), zinc chloride (ZnCl₂), ammonium chloride (NH₄Cl), and sulfuric acid (H₂SO₄).

15. A method of manufacturing an all-solid state primary film battery comprising:
preparing a first polymer film and a second polymer film;
forming a first conductive layer on the first polymer film to form a first polymer current collector film;
forming a second conductive layer on the second polymer film to form a second polymer current collector film;
forming a first electrode layer on the first polymer current collector film;
forming a second electrode layer on the second polymer current collector film;
forming a polymer electrolyte layer comprising aqua-based electrolytic solution between the first electrode layer and the second electrode layer.

16. The method of claim 15, wherein the forming the first conductive layer comprises coating a conductive carbon paste, a nano metal particle paste, a conductive polymer or an ITO paste on the first polymer film, or attaching a conductive carbon tape to the first polymer film.

17. The method of claim 15, wherein the forming the second conductive layer comprises coating a conductive carbon paste, a nano metal particle paste, a conductive polymer, or an ITO paste on the second polymer film, or attaching a conductive carbon tape to the second polymer film.

18. The method of claim 15, wherein the forming the first electrode layer comprises coating an anode active material slurry on the first conductive layer of the first polymer current collector film.

19. The method of claim 15, wherein the forming the second electrode layer comprises coating a cathode active material slurry on the second conductive layer of the second polymer current collector film.
